(19) United States
(12) Patent Application Publication
(10) Pub. No.: US 2006/0190576 A1
(43) Pub. Date: Aug. 24, 2006

(54) Scheduling method of advertisement/broadcasting and management system and method

(76) Inventors: Nam-Yul Lee, Daejeon (KR); Kee-Joo Yoon, Seoul (KR)

Correspondence Address: DILWORTH & BARRESE, LLP, 333 EARLE OVINGTON BLVD., UNIONDALE, NY, 11553, US

(21) Appl. No.: 10/564,124

(22) PCT Filed: Oct. 21, 2003
(86) PCT No.: PCT/KR03/02208

§ 371 Date: Jan. 9, 2006

(30) Foreign Application Priority Data
Aug. 26, 2003 (KR) 1020030059321

(51) Int. Cl. G06F 15/173

(52) U.S. Cl. 709/223; 709/225

(57) ABSTRACT

A scheduling method of advertisement/broadcasting of Integrated Broadcasting System based on network and a Centrally Controlled Management System using screen partition and a method thereof for control image transmitting of advertisement/broadcasting are disclosed. This invention interrupts broadcasting on playing now and broadcasts urgent broadcasting. After finish of urgent broadcasting interrupted and reserved broadcasting are transmitted again. This invention transmits various advertisement images through Internet in real time for optimal effects of advertisement, which is managed by a centrally control method. An Integrated Broadcasting System comprises a Content Distribution Server, a Traffic Management Server, a Security Server, a IBS Control Server, an IBS Administrator Interface, an IBS Terminal Server, a plurality of IBS Media Servers.

### BACKGROUND OF THE INVENTION

1. Field of the Invention

This invention relates to a scheduling method of advertisement/broadcasting based on networks and a Centrally Controlled Management System using screen partition and a method thereof.

2. Description of the Prior Arts

Existing systems for broadcasting or transmitting images through networks cannot modulate images appearing on screens freely but operate according to fixed screens fixed by manufacture. In addition the systems have defects in that free screen composition cannot be achieved automatically because screen modes that were already set by schedules change into other modes automatically by the systems whether they are parted screens or not. Also the systems have defects in that they cannot provide different contents as well as free screen mode partition for each screen at the same time.

Moreover the existing systems have defects in that they provide same contents uniformly in a designated broadcasting area according to a fixed broadcasting schedule and moving images should be stored and kept at broadcasting terminals directly because contents are not provided online but offline and it is impossible to perform real time control of broadcasting and real time broadcasting and a manager has to check a broadcasting terminal directly and the existing systems should organize advertisements only according to time and so a low efficiency is caused and it is difficult to organize distinctive advertisements by date, time and area respectively.

And because the existing systems for broadcasting and transmitting images using networks were invented for specific purposes (such as education, broadcasting, advertisement and other application fields) it is difficult to use them for other purposes and accordingly a general-purposed system usable in various fields is needed.

### SUMMARY OF THE INVENTION

In view of the problems described above, an object of the present invention is to provide a scheduling method of advertisement/broadcasting based on networks including LAN/WAN and Internet and a Centrally Controlled Management System using various screen partitions and a method thereof.

This invention has another object to provide techniques to embody a central monitoring function, a various screen partition function, a contents compression/encryption function for transmission, a real-time contents distribution function, a network load control function, a designation function of broadcasting schedules and a contents grouping function.

The other object, features and advantages of the present invention will become more apparent by reading the detailed description of the following invention and making reference to the accompanied drawings.

### BRIEF DESCRIPTION OF THE DRAWINGS

FIG. 1 illustrates a preferred embodiment of a Centrally Controlled Management System using screen partition for a scheduling of advertisement/broadcasting based on networks;

FIG. 2 illustrates a flow chart of Inner Data Processing of the system shown in FIG. 1;

FIG. 3 illustrates an example of schedule transmission between an IBS Control Server and an IBS Terminal Server of the system shown in FIG. 1;

FIG. 4 illustrates an example of inner structure of a database for a general/urgent broadcasting schedule locating in an IBS Control Server of the system shown in FIG. 1;

FIG. 5 is a flow chart of an operation of an IBS Terminal Server of the system shown in FIG. 1;

FIG. 6 illustrates an example of structure of contents groups according to the present invention;

FIG. 7 illustrates a contents encryption/compression process in a Security Server of the system shown in FIG. 1;

FIG. 8a illustrates an example of a Tree Structure of a broadcasting shop according to the present invention;

FIG. 8b illustrates an example of construction information of a broadcasting shop according to the present invention;

FIG. 9a illustrates an example of contents management for common TXT, html, web documents according to the present invention;

FIG. 9b illustrates an example of media management for contents of a broadcasting multimedia according to the present invention;

FIG. 10a illustrates an example of Unit Content Management according to the present invention;

FIG. 10b illustrates an embodiment of a Unit Content File according to the present invention;

FIG. 11a, 11b and 11c are examples of Group Content Management according to the present invention;

FIG. 11d illustrates an example of structure of a Group Content File according to the present invention;

FIG. 12a illustrates an example of Panel Content Management according to the present invention;

FIG. 12b illustrates an example of structure of a Panel Content File according to the present invention;

FIG. 13a illustrates an example of Frame Appointment according to the present invention;

FIG. 13b illustrates an example of contents type appointment supported by an IBS system according to the present invention;

FIG. 13c illustrates an example of PCS appointment according to the present invention when a multimedia contents type is selected;

FIG. 13d illustrates an example of URL appointment according to the present invention when a web contents type is selected;

FIG. 14a illustrates an example of organization of a whole broadcasting schedule using Frame Content Management according to the present invention;

FIG. 14b illustrates an example of structure of a Frame Content File according to the present invention;

FIG. 15 illustrates an example of management of a broadcasting schedule list according to the present invention;

FIG. 16a illustrates an example of construction and control of parted screens according to the present invention;

FIG. 16b illustrates an example of OCX construction necessary to screen construction and control according to the present invention,

FIG. 17 illustrates an example of basic types about a Screen Frame, which can operate at an IBS terminal according to the present invention;

### SIMPLE EXPLANATION ABOUT IMPORTANT PARTS OF DRAWINGS

10: Unit Content (UC)
20: Group Content Service (GCS)
30: Panel Content Service (PCS)
40: Frame Content Service (FCS)
100: Content Distribution Server (CDS)
200: Traffic Management Server (TMS)
210: Control unit
220: GLB Master
230: SLB Master
240: Communication module
250: Database
300: Security Server (SS)
300′: Security Client
310,310′: Listen Socket
320: SSL Decryption
320′: SSL Encryption
330,330′: Connection communication module
400: IBS Control Server (IBSCS)
410: Broadcasting Schedule Control Unit (BSCU)
420: Content Monitoring Control Unit (CMCU)
430,630,710: Content Sender/Receiver Control Unit (CTCU)
440: Shop Management Database Control Unit (SMDCU)
450: General Broadcasting Schedule Database (GBSD)
460: Urgent Broadcasting Schedule Database (UBSD)
470,640,720: Content Database (CD)
480: Shop Management Database (SMD)
500: IBS Administrator Interface (IBSAI)
510: General Broadcasting Schedule Registration Unit (GBSRU)
520: Urgent Broadcasting Schedule Registration Unit (UBSRU)
530: Contents Synchronization Unit (CSU)
540: IBS Terminal Registration Unit (IBSTRU)
600: IBS Terminal Server (IBSTS)
610: Broadcasting Screen Control Unit (BSCU)
620: Login Control Unit (CU)
700: IBS Media Server (IBSMS)
800: Broadcasting screen
1000: Integrated Broadcasting System (IBS)
GLB: Global Load Balancing
https: Secure HTTP
OCX: OLE Control Extensions
SLB: Server Load Balancing
SSL: Secure Sockets Layer

### DESCRIPTION OF THE PREFERRED EMBODIMENTS

I. A Centrally Controlled Management System for Scheduling of Advertisement/Broadcasting

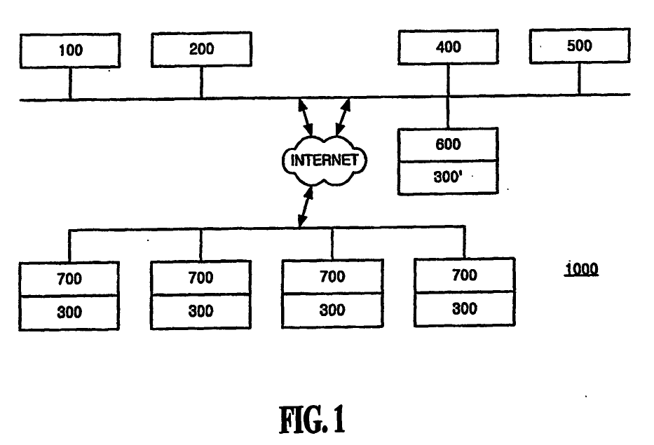

According to the present invention, a Centrally Controlled Management System for scheduling of advertisement/broadcasting based on networks is shown in FIG. 1 and is an Integrated Broadcasting System (IBS)(1000) that sends moving images according to real-time/reserved schedules to output terminals of all areas or advertisement points by using a centrally controlled method based on networks including LAN, WAN and Internet and controls schedules of advertisement/broadcasting.

This System comprises an IBS Control Server (IBSCS)(400) performing a main role of IBS and having a Broadcasting Schedule Control Unit (410), a Content Monitoring Control Unit (420), a Content Sender/Receiver Control Unit (430), a Shop Management Database Control Unit (440), a General Broadcasting Schedule Database (450), an Urgent Broadcasting Schedule Database (460), a Content Database (470) and a Shop Management Database (480); a Security Server (SC)(300) encrypting and compressing important contents when each broadcasting content is uploaded or downloaded between severs or areas and using a protection technique of transmission path tunneling that cuts off outer illegal usage of contents in transmission processes for security; an IBS Administrator Interface (IBSAI)(500) used as a management tool of GUI environment and providing a function of every environmental setup for driving an IBS and appointment of broadcasting schedules, a management function of broadcasting points and a function of contents grouping and a function of that there is no restriction of OS platforms in installation and operation of an IBS owing to development in JAVA environment and having a general broadcasting schedule registration unit (510), an urgent broadcasting schedule registration unit (520), a contents synchronization unit (530) and an IBS terminal registration unit (540); an IMS Terminal Server (IBSTS)(600) being driven at each broadcasting terminal of an IBS and downloading broadcasting time and contents that would play at the broadcasting time and playing broadcasting through various output mediums including displaying devices using various types of monitors comprising a CRT, a PDP, an LCD and a projector being a projecting device, wherein all playing environments about screen structure, the number of times of broadcasting play, screen partition and broadcasting time are downloaded from Said IBSCS (400) and having a broadcasting screen control unit (610), a login control unit (620), a Content Sender/Receiver Control Unit (630) and a Content Database (640); plurality of IBS Media Servers (IBSMS)(700) transmitting contents organized and synchronized by server clustering to said IBSTS (600) and comprising a Content Sender/Receiver Control Unit (710) transmitting created, modified and deleted contents from said IBSCS (400) in real time and a Content Database (720) receiving and storing original advertisement contents; a Traffic Management Server (TMS)(200) making broadcasting contents be downloaded from an IBSMS (700) with the best efficiency by using information of network distance between said IBSTS(600) and plurality of IBSMSes (700) and system resources of said IBSMSes (700) and modulating load distribution and thereby providing a path through which advertisement contents and broadcasting schedules can be downloaded optimally and providing a load balancing function between said IBSMSes (700) having the same functions by using server information including CPU, memory and session and managing transmission traffic of contents; and a Content Distribution Server (CDS)(100) monitoring contents change of said plurality of IBSMSes (700) automatically and distributing changed contents to pre-designated servers in real time and synchronizing contents of said pre-designated servers and making all IBSMSes (700) always keep the same contents, wherein said each element (100)(200)(300)(400)(500)(600)(700) operates organically one another and performs organization and management of broadcasting schedules, urgent broadcasting processes and screen partition processes.

At the present invention, Said each element (100)(200)(300)(400)(500) (600)(700) is a server module embodied in software form and can be organized in each hardware separately and furthermore Said Content Distribution Server (100), Said Traffic Management Server (200), Said Security Server (300) and said IBS Control Server (400) can be installed in a hardware at the same time. That is, each server of a CDS (100), a TMS (200), a SS (300), an IBSCS (400) is independent on hardware and can be organized distributed.

An IBS (1000), according to the present invention, transmits moving images in real time or according to reserved schedules to output mediums of all areas or advertisement points by using a centrally controlled method through networks.

Hereinafter, the organization and operating mechanism of the present invention will be described in detail with the accompanied drawings. FIG. 1 is a schematic diagram of an IBS (1000) according to the present invention.

1. Content Distribution Server

A Content Distribution Server (100) monitors contents' change of a plurality of IBSMSes (700) automatically and distributes and synchronizes the changed contents to pre-designated servers in real time and performs synchronization so that every IBS Media Server can always keep the same contents.

2. Traffic Management Server

A Traffic Management Server (200) makes broadcasting contents be downloaded from an IBSMS (700) with the best efficiency by using information of network distance between said IBSTS (600) and plurality of IBSMSes (700) and system resources of said IBSMSes (700) and modulates load distribution and thereby provides a path through which advertisement contents broadcasting schedules can be downloaded optimally.

And a TMS (200) provides a load balancing function between said IBSMSes (700) having the same functions by using server information including CPU, memory and session and an intelligent GLB (global load balancing) and SLB (server load balancing) function. Said GLB distributes load between locally distributed POPs and each IBSMS (700) by HOP policies among POPs, PING policies and policies defined by a manager, wherein POP is a group of IBSMSes (700), and said SLB distributes server's load by using server information including CPU, memory and session among all IBSMSes (700) having the same contents.

Here HOP defines number of routers of network sections between IBSTS (600) and IBSMSes (700). For example, if contents pass through a plurality of routers, network connection may be slow sometimes.

PING is a command in order to confirm condition of connection of communication devices between IBSTS (600) and IBSMSes (700). PING is used to confirm whether IBSTS (600) and IBSMSes (700) are being driven, whether communication networks are connected to each other, and uses Internet control message protocols. A Traffic Management Server (200) provides the optimal path between an IBS Terminal Server (600) and IBS Media Servers (700) by using said GLB and SLB function, and the server (200) induces that the optimal services be provided.

A Traffic Management Server (200) comprises a GLB Master (220) to select the optimal POP in case networks are distributed to organize several POPs, an SLB master (230) to embody server load balancing between media servers (700), a communication module (240) for data transmission, a control unit (210) controlling each communication module (240) and a database (250) for storing GLB information and SLB information.

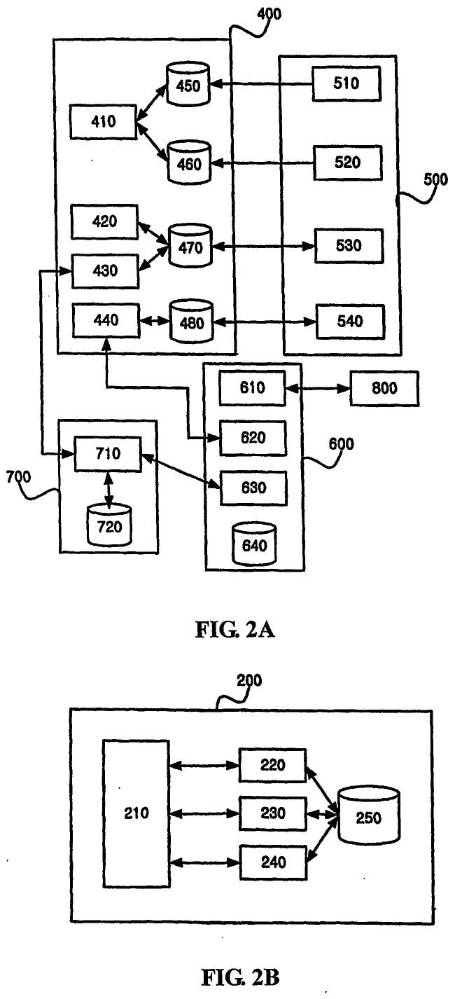

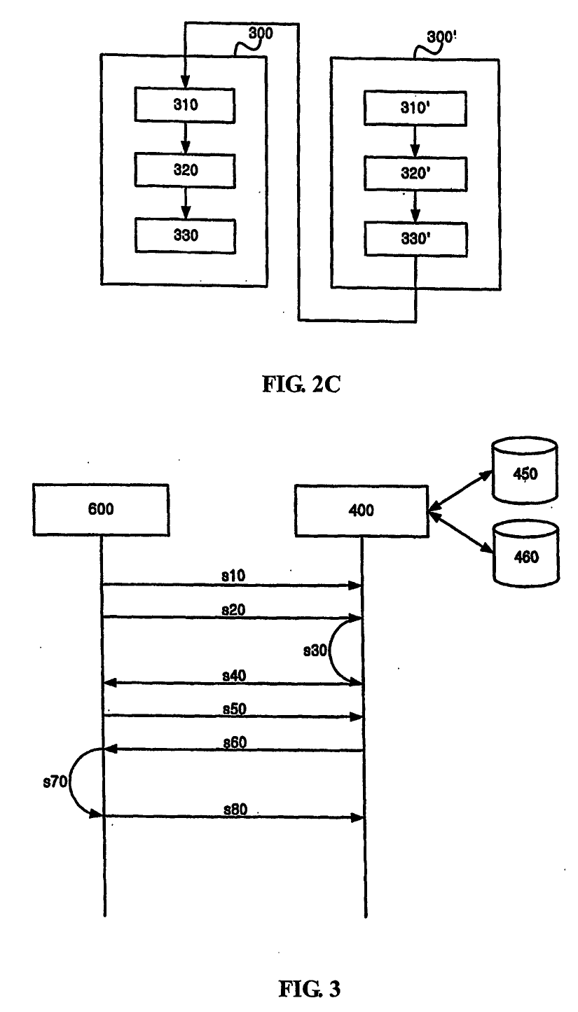

As shown in FIG. 2b, a TMS (200) has a control unit (210), a GLB Master (220), an SLB master (230), a communication module (240) and a database (250).

3. Security Server

A Security Server (300) provides a function of encrypting and compressing important contents between servers or areas when each broadcasting content is uploaded or downloaded. A SS (300) uses a protection technique of transmission path tunneling that cuts off outer illegal usage of contents in transmission processes and provides perfect security. Said protection technique of transmission path tunneling is based on general network techniques that embody encapsulation of data in data transmission between every OSI 7 Layer.

As shown in FIG. 2c, a Security Server (300) installed in an IBSMS (700) and a security client (300) installed in an IBSTS (600) have listen sockets (310)(310′), SS encryption/decryption modules (320)(320′) and a connection communication module (330) respectively. Left part of FIG. 2c shows a configuration of an SS (300) installed in an IBSMS (700). An SS (300′) comprises a listen socket (310′), an SSL encryption (320′) and a connection communication module (330′).

Listen sockets (310)(310′) always maintain wait status in order to check whether data for encryption/decryption is generated or not and an SSL encryption (320) performs encryption and connection communication modules (330)(330′) is connected to a real Security Server (300) or a security client (300′).

4. IBS Control Server

An 113S Control Server (400) according to the present invention plays a main role of an IBS (1000) and performs control function about general advertisement and broadcasting schedules, control function about urgent broadcasting, management function about customer/terminal information and control function about contents monitoring and contents transmitting and receiving and communicates with an admin user interface (500).

A Broadcasting Schedule Control Unit (410) stores general broadcasting schedules and urgent broadcasting schedules set up at an IBSAT (500) in a General Broadcasting Schedule Database (450) and an Urgent Broadcasting Schedule Database (460) respectively and takes charge of every control related to schedule transmission when an IBS Terminal Server (600) demands broadcasting schedules.

A Content Monitoring Control Unit (420) monitors contents change in an IBS Control Server (400) in real time. That is, it monitors creation, modification and deletion of contents at Kernel Level in real time. For example, if contents of specially monitored directories stored in an IBS Control Server (400) were modified, created and deleted, it can monitor these contents at Kernel Level in real time and transmit commands for contents synchronization to a Content Sender/Receiver Control Unit (430).

A Content Sender/Receiver Control Unit (430) transmits said modified, deleted and created contents to a plurality of IBS Media Servers (700) through designated contents routing paths respectively. Distribution of contents is performed in real time by a Content Monitoring Control Unit (420) and a Content Sender/Receiver Control Unit (430).

A Shop Management Database Control Unit (440) has function of login authentication of an IBS Terminal Server (600), function of registration, modification and deletion of an IBS Terminal Server (terminal) (600) and function of IP address confirmation for checking the existence of an IBS Terminal Server (600) in various network environments including ADSL and leased lines etc.

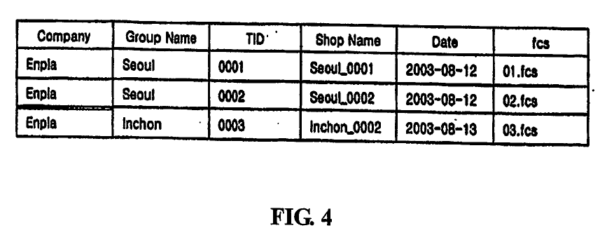

A General Broadcasting Schedule Database (450) stores information of broadcasting terminals, broadcasting time and broadcasting schedules. The structure of a schedule database (450) is illustrated in FIG. 4 in detail.

An Urgent Broadcasting Schedule Database (460) is a space, which stores information of urgent broadcasting and has the same structure with a General Broadcasting Schedule Database (450).

A Content Database (470) is a space storing contents of advertisements or broadcasting and stores directory and file structure using file system of an IBS Control Server (400).

A Shop Management Database (480) is a space storing shop information for an IBS Terminal Server (600) and information of Identification and password.

5. IBS Administrator Interface

An IBS Administrator Interface (500), a management tool of GUI environment, provides function of every environmental setup for driving an IBS and designating broadcasting schedules, function of broadcasting terminal management and function of contents grouping. And an IBSAI (500) has no restriction of OS platforms in installation and operation of it owing to development in JAVA environments. Function of broadcasting terminal management is to record information of PC requirements, memory, disc size, whether ADSL is used or not, a manager, telephone number of a manager, mobile phone number of a manager, driving frame size etc.

An IBS Administrator Interface (500) provides content management, schedule management, administrator account management including manager registration and manager privilege setting, graphic management function for centrally controlling shop management etc.

A general broadcasting schedule registration unit (510) provides function of controlling set-up, modification and deletion of general broadcasting schedules organized by date and by terminal.

An urgent broadcasting schedule registration unit (520) provides function of controlling set-up, modification and deletion of urgent broadcasting schedules organized by date and by terminal, wherein the urgent broadcasting is distinguished from the general broadcasting.

A contents synchronization unit (530) provides function of uploading and downloading contents from and to a remote IBS Control Server (400) and deleting contents of servers.

A terminal registration unit (540) provides function for registering Identification, password and server environments of an IBS Terminal Server (600) for transmission of broadcasting.

A general broadcasting schedule registration unit (510), an urgent broadcasting schedule registration unit (520), a contents synchronization unit (530) and an IBS terminal registration unit (540) will be described later in detail.

6. IBS Terminal Server

An IBS Terminal Server (600) is being driven at every broadcasting terminal of an IBS (1000) and downloads broadcasting schedules and broadcasting contents to be broadcasted at broadcasting time and drives broadcasting through various output mediums. All driving environments like screen structure, the number of times of broadcasting, screen partition and broadcasting time, are downloaded from an IBS Control Server (400).

A broadcasting screen control unit (610) controls how to arrange several panels in one frame.

A login control unit (620) controls authentication of IP address, other information of connection environment set-up, Identification and password of an IBS Control Server (400) connecting for login authentication of each IBS Terminal Server (600). A Content Sender/Receiver Control Unit (630) transmits and receives contents, which were modified, deleted and created from the optimal server among a plurality of IBS Media Servers (700). In every process of contents transmission and receive, contents distribution is performed in real time by a Content Sender/Receiver Control Unit (430).

A Content Database (640) stores contents received from the Content Sender/Receiver Control Unit (630) in physical hard disks.

7. IBS Media Server

A Content Sender/Receiver Control Unit (710) embodies transmission of contents that were created, modified and deleted from an IBS Control Server (400) in real time. A Content Sender/Receiver Control Unit (710) synchronizes original contents to each IBS Media Server (700) and contents transmitted by the Content Sender/Receiver Control Unit (710) are stored in a Content Database (720).

A Content Database (720) is organized into directory and file forms in hard disk areas of an IBS Media Server (700).

FIG. 2 illustrates a flow chart of Inner Data Processing of the system shown in FIG. 1. If information of broadcasting schedules, contents and customers is registered through an IBS Administrator Interface (500), an IIBS (1000) transmits this information to an IBS Control Server and stores the registered information in databases (450)(460)(470)(480).

An IBS Control Server (400) monitors content's change based on said transmitted information through a Content Monitoring Control Unit (420) in real time and transmits information related to changed contents to each 1IBS Media Server (700) through a Content Sender/Receiver Control Unit (430) and this information is stored in a database (720) of an IBS Media Server (700).

Users (IBS terminals) log in an IBS Terminal Server (600) and get authentication and then connect to an IBS Control Server (400) and download contents through an optimal IBS Media Server (700) and store contents in a database of an IBS Terminal Server (600).

When it is broadcasting time, an IBS Terminal Server (600) broadcasts corresponding contents by controlling a broadcasting screen (800).

II. A Scheduling Method of Advertisement/Broadcasting Based on Networks and a Centrally Controlled Management Method Through Screen Partition

FIG. 3 illustrates a general/urgent broadcasting schedule transmission method between an IBS Control Server (400) and an IBS Terminal Server (600). An IBS Terminal Server (600) inputs ID (Terminal ID. Its abbreviation is TID.) set up when terminals are registered at first, password and company name and requests authentication (s10). If the authentication is successful, an IBS Terminal Server (600) asks to an IBS Control Server (400) by a predetermined period whether broadcasting schedules exists or not. That is, the server (600) requests broadcasting schedules (s20). A manager can set up said predetermined period freely. To use a variable period like this is better than for an IBS Control Server (400) to check the status of an IBS Terminal Server (600) every fixed period because to use a variable period reduces server load and increases server efficiency.

Therefore if an IBS Media Server (700) checks the status of each IBS Terminal Server (600) frequently and transmits broadcasting lists and schedules, a problem that hardware specification like memory and CPU should be upgraded when number of IBS Terminal Servers (600) increases, can be prevented previously.

According to the request for confirmation of existence of broadcasting schedules by an IBS Terminal Server (600), an IBS Control Server (400) searches contents of a General Broadcasting Schedule Database (450) or an Urgent Broadcasting Schedule Database (460) and confirms whether broadcasting schedules exist or not (s30). An IBSCS (400) notifies the confirmation result to an IBSTS (600)(s40).

If schedules exist as a result of confirmation according to the notification, an IBSTS (600) requests detailed schedules about general or urgent broadcasting schedules to the IBSCS (400) (s50). An IBSTS (600) downloads detailed schedules from the IBSCS (400) according to the request (s60).

An IBS Terminal Server (600) sends broadcasting according to the running time of broadcasting schedules (s70). Therefore if general broadcasting runs already, it is interrupted and new urgent broadcasting is controlled and runs. And after running of the urgent broadcasting, it returns to the interrupted broadcasting status and general broadcasting runs again (s80).

An IBS Terminal Server (600) has information of panel of each divided frame and information of broadcasting lapse time and so it can provide continuity of previous broadcasting after running of urgent broadcasting. In addition to, an IBS Terminal Server (600) transmits an IBS Control Server (400) the information about whether the present running broadcasting is urgent broadcasting or general broadcasting and so it is possible to check the status of the present broadcasting. The reason to do so is so that if the present running broadcasting corresponds to urgent broadcasting, the urgent broadcasting can run according to the priority of broadcasting orders although there is a broadcasting request according to another broadcasting schedule at present time.

FIG. 4 illustrates organization of schedule databases (450)(460) for general broadcasting or urgent broadcasting. Schedule databases (450) (460) store information of company name, group name, TID, shop name, date and FCS etc. in file form.

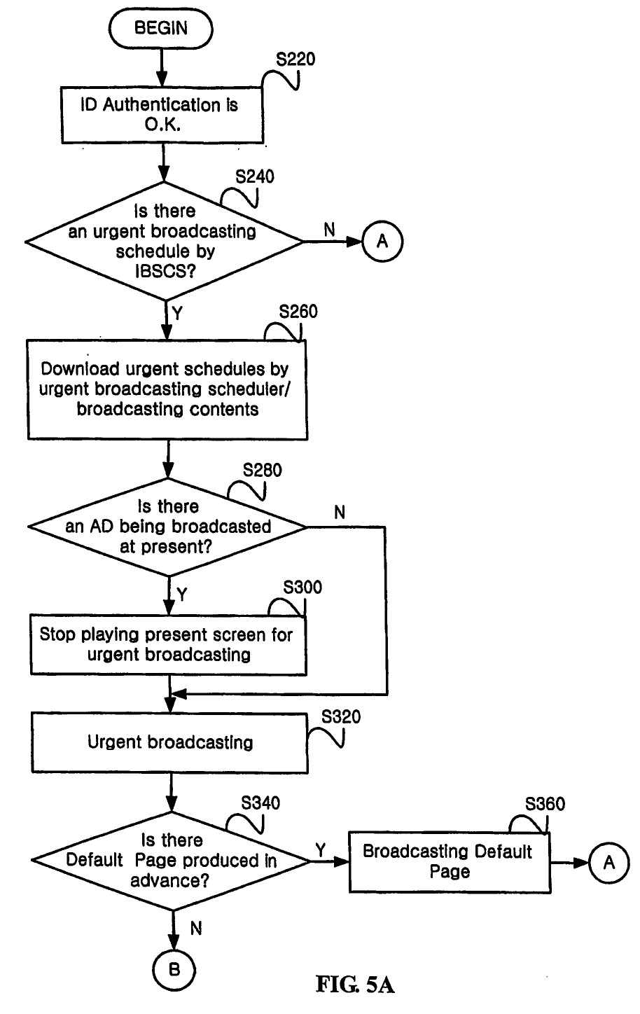

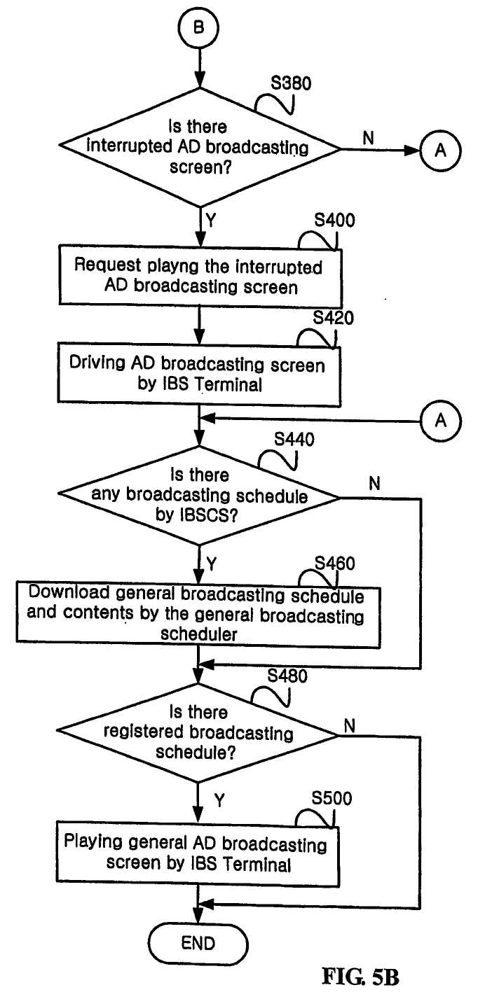

FIG. 5 illustrates a flow chart of operation of an IBS Terminal Server (600). An IBS Terminal Server (600) is a PC or a server that is installed at each broadcasting terminal. An IBS Terminal Server (600) gets authentication for login (s220) and checks whether there are urgent broadcasting schedules through an IBS Control Server (400). If there are urgent broadcasting schedules, urgent schedules produced by an urgent broadcasting scheduler and broadcasting contents are downloaded (s260).

The IBS Control Server (400) checks whether there is advertisement running at present in the IBS Terminal Server (600)(s280) and if there is broadcasting running at present, the server (400) interrupts running of current screen (s300) and runs urgent broadcasting (s320). But as a result of the confirmation (s280), if there is no advertisement running at present, the IBS Terminal Server (600) runs urgent broadcasting without delay (s320).

The IBSTS (600) checks whether there is organization of default pages produced previously (s340) and if there is, it runs default pages (s360) but if there is no organization, the server (600) checks whether it is interrupted advertisement broadcasting or not (s380). As a result of the confirmation, if it is interrupted broadcasting, then the IBSTS (600) requests to run the previously interrupted advertisement broadcasting (s400) and runs advertisement broadcasting (s420).

Meanwhile as a result of the confirmation, if there is no urgent broadcasting schedules (s240) or if default pages were broadcasted (s360) or if there is no interrupted broadcasting (s380) or if the IBS Terminal Server (600) runs advertisement broadcasting (s420), then the IBS Control Server (400) checks whether there are general broadcasting schedules (s440) and as a result of the confirmation, if there are general broadcasting schedules, the server (400) downloads general broadcasting schedules produced by a general broadcasting scheduler and broadcasts contents (s460).

As a result of the confirmation, if there is no general broadcasting schedules (s440), or if it downloads general broadcasting schedules and broadcasting contents (s460), then it checks whether there are registered broadcasting schedules and if there are registered broadcasting schedules, then it runs general advertisement broadcasting and terminates but if there are no registered broadcasting schedules, then it terminates at once (s500).

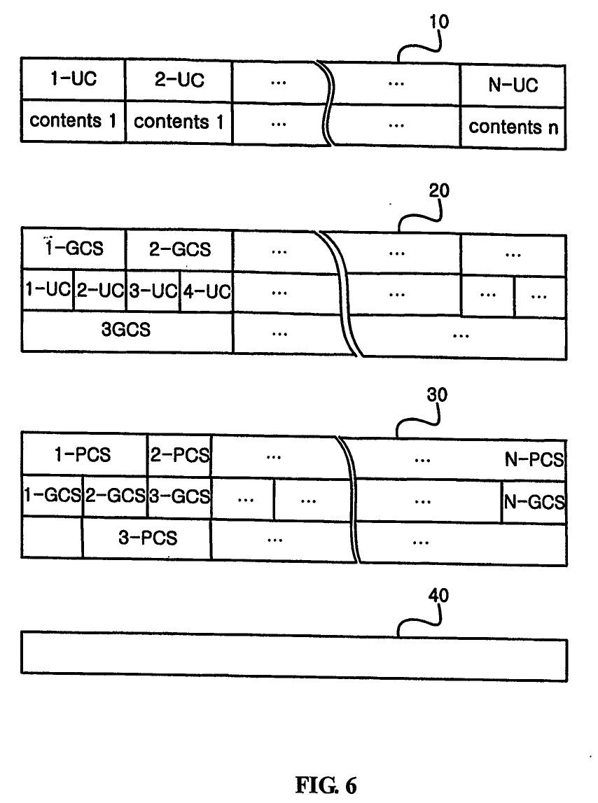

FIG. 6 illustrates an example of structure of contents groups according to the present invention. An IBS system (1000) embodies basic scheduling by combination of four basic elements, a UC (unit content)(10), a GCS (group content schedule)(20), a PCS (panel content schedule)(30) and an FCS (frame content schedule)(40).

A UC (10) expresses each of multimedia files, a frame expresses a whole screen and a panel expresses each individual screen divided into several parts. A GCS (20) is a collective concept of UC (10) files, a PCS (30) is a collective concept of GCS (20). An FCS (40) is a collective concept of PCS (30), GCS (20) and UC (10). An FCS (40), in addition, is a unit of a day schedule or a unit of a schedule for a certain period schedule and consists of proper combination of UC (10), GCS (20), PCS (30) and FCS (40).

In the organization of the above elements as a basic, item framework and broadcasting contents can be organized differently according to broadcasting terminals although a company is the same one.

Each panel located in a frame can be understood as a space concept capable of running advertisement and broadcasting by using UC (10), GCS (20), PCS (30) and FCS (40) that are single contents scheduled in advance. That is, the broadcasting time of each panel in a same frame may be different each other in beginning and ending points. Broadcasting schedules according to each broadcasting terminal are scheduled and the corresponding broadcasting runs day after day. Repeatedly an IBS (1000) can transmit contents variously and flexibly by using contents grouping concepts.

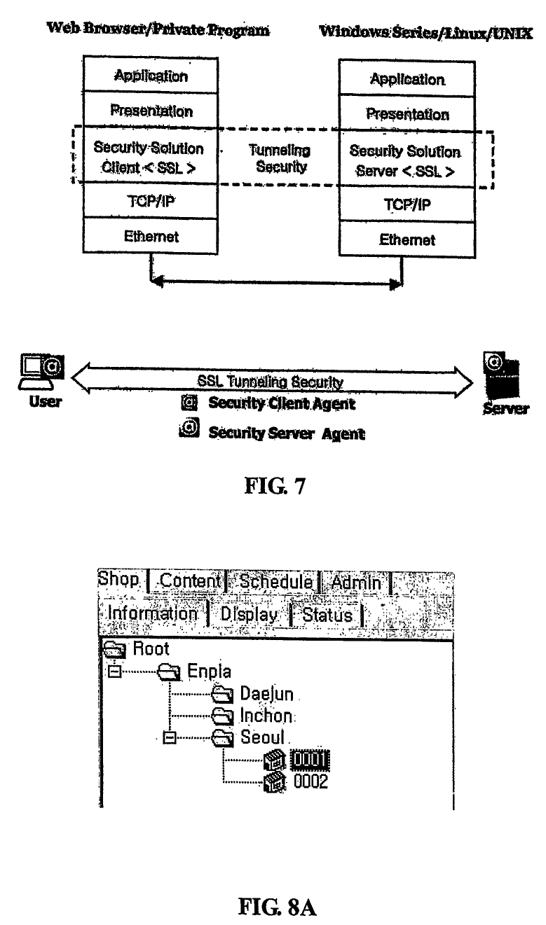

FIG. 7 illustrates an embodiment of a security solution, that is, contents encryption process. Left side of the Figure is a user side and right side is a server side. The user side connects with a server by using of a web browser having exclusive program provided by the server side and the server can be organized by using various operating systems such as Windows series, Linux and UNIX etc.

The user side and the server side are based on an OSI (open system interconnection) reference model that is a communication protocol developed by ISO (international standards organization) and OSI has layer structure as shown in FIG. 7.

That is, FIG. 7 illustrates an embodiment of structure of a security solution according to the present invention. In a user side, at the highest layer exists an application program, at the very layer below the highest layer exists presentation, at the next layer exists a security solution client (SSL), at the next layer exists a TCP/IP layer and at the lowest layer exists Ethernet. In server side, at the highest layer exists an application program, at the next layer exists presentation, at the next layer exists a security solution server (SSL), at the next layer exist a TCP/IP layer and at the lowest layer exists Ethernet.

In the encryption process of contents of the present invention a user gets authentication of an open key through a plurality of authentication methods such as Identification, password and finger print etc and connects with a server program. The user authenticated by the process uses a server application. The user can protect contents and important data by using a method for encryption or compression according to each step during data transmission on Internet section. In addition, as shown in FIG. 7 illustrating an embodiment of structure of a security solution, it guarantees safe data transmission between a TCP/IP layer and an Application layer on Internet section.

From the point of view of a security solution, it embodies HTTPS web encryption if a user uses IE (Internet Explorer) of MS Company and if a user uses other exclusive program, a separate Client Agent is needed to the connection with Security Server. And both the user side and the server side use a tunneling security technique for a security solution.

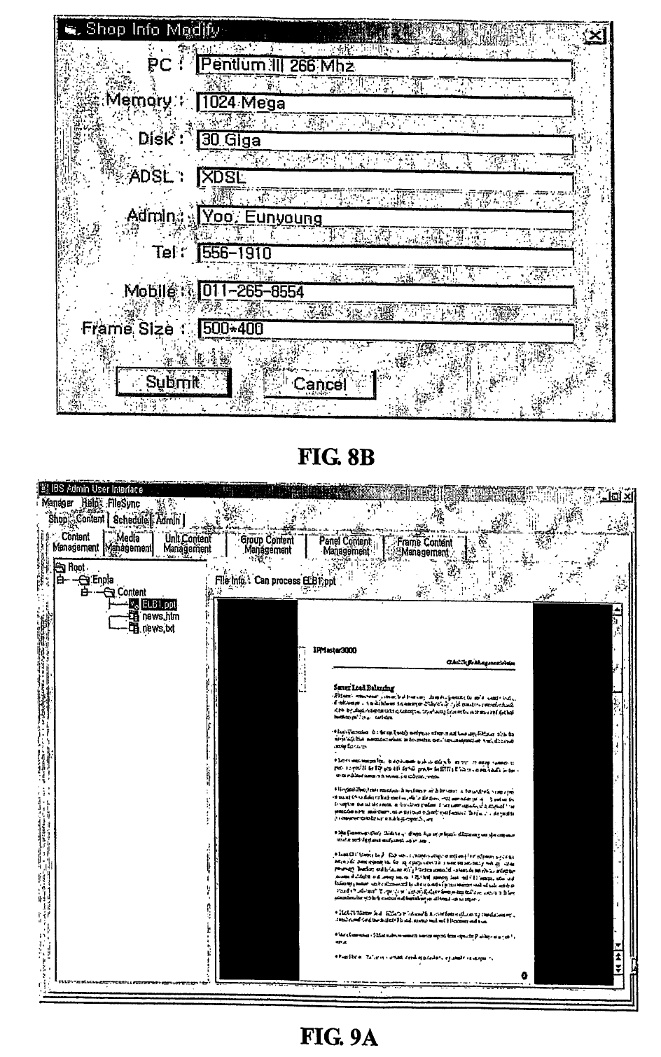

FIG. 8 illustrates an example of registration and management of IBS terminals through an IBS Terminal Server (600). As shown in this example, tools like 'shop, contents, schedule, admin, detailed information, screen status and present status board are installed at a tool bar for registration and management. And at the below of the tools, a screen window is installed to check the structure of IBS terminals by using Tree Structure.

As shown in an example of FIG. 8a, the structure of IBS terminals can be checked through Tree Structure. In FIG. 8a, a customer named Enpia consists of three groups Daejun, Incheon and Seoul and the Seoul group consists of broadcasting terminals 0001 and 0002.

FIG. 8b illustrates an example of input information when the terminals are registered. Particularly this case shows an input example to modify shop information. In registration of terminals, terminal Identification and password are inputted and terminals are registered and detail information about hardware of the terminals' computers is recorded. The Information inputs information about the completion of CPU of PC, memory capacity, disk capacity, information about whether ADSL is used or not, operator's name, operator's telephone number, operator's mobile phone number, basic frame size etc.

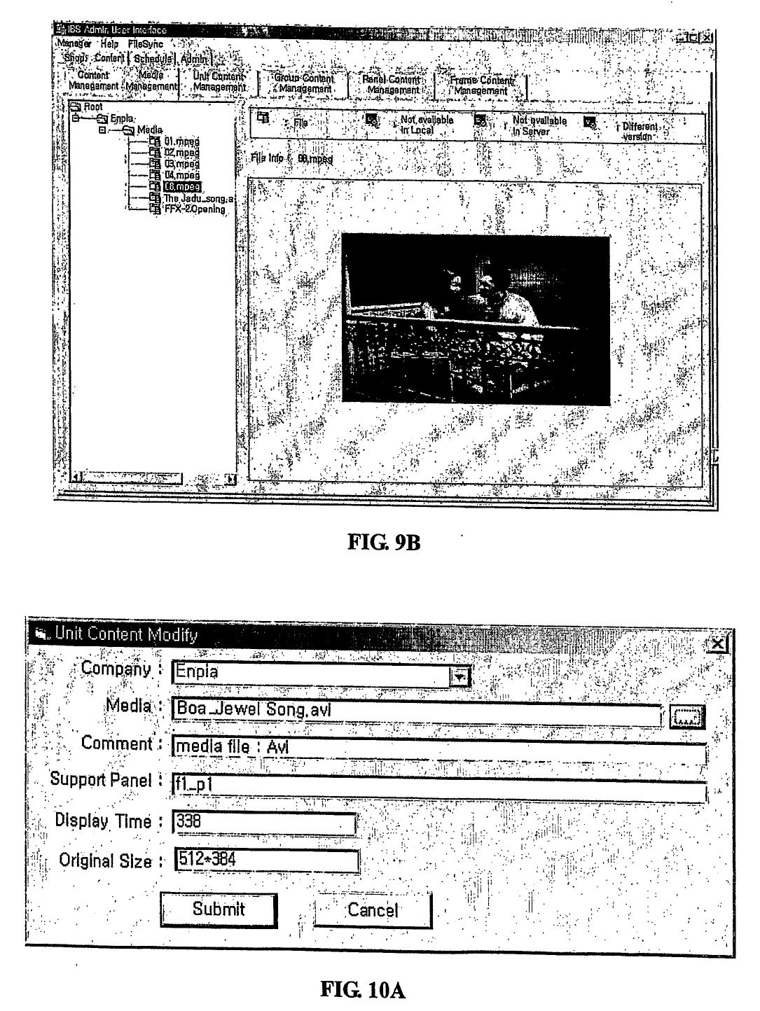

FIG. 9a illustrates a method for centrally managing contents through an IBS Administrator Interface (500). An IBS Administrator Interface (500) provides function for managing contents, media, unit content, group content, panel content and frame content.

In FIG. 9a, the contents are classified into files having common text format like common PPT, TXT and HTML and multimedia files like MPEC; AVI and MP3 and managed. And contents management items shows contents' list and provides file information and file review function.

FIG. 9a illustrates Tree Structure about root, “Enpia”. and “Content”, in particular, illustrates a case of that PPT, HTML and TEXT files exist normally in a server. In selecting content from Tree Structure, the contents of corresponding files can be checked by file information (for example, whether the file is normal or not) and the file review function.

Management item of media files shown in FIG. 9b provides function for checking whether corresponding media files are normal or not, whether they exist locally, whether they exit in a server, version information, file information and file review function. FIG. 9b illustrating Tree Structure about root, Enpia and Content, shows a case of that multimedia files like MPEG, MP3 and AVI exist in a server normally. If each content is selected from Tree Structure, it can be checked whether corresponding media files are normal or not, whether they exist locally, whether they exist at a server, version information, file information and file review function. The above function can check normal operating status of uploaded or downloaded files and so it is possible to check whether contents files are damaged or not, and if the corresponding files are abnormal files, then it is possible to upload or download them again. After downloading server's contents files to a local PC, contents are selected and can be reviewed through the review function.

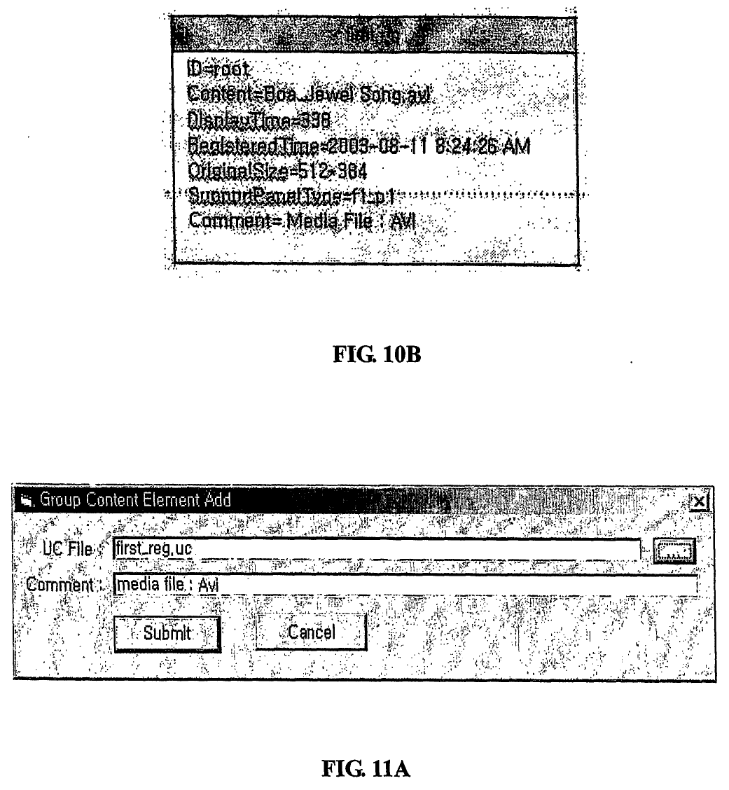

FIG. 10a illustrates an example of management of unit content. Unit content (10) is a minimal unit of IBS contents management. The unit content (10) stores information about names of companies performing contents registration, media file names, explanation about files, display time of files, panel size of width x height, names of customers, contents types, contents indexes, keywords etc.

In advertisement contents, the information about corresponding advertisers can be searched by using the information of advertisement indexes and keywords. In registering unit content, if contents are registered at media item of FIG. 9, the values of other items are inputted automatically. That is, display time and original panel size of a corresponding media file are automatically registered.

FIG. 10b illustrates an embodiment of organization of Unit Content Files of an IBS Terminal Server (600). The organization of Unit Content File is based on input items of the FIG. 10a.

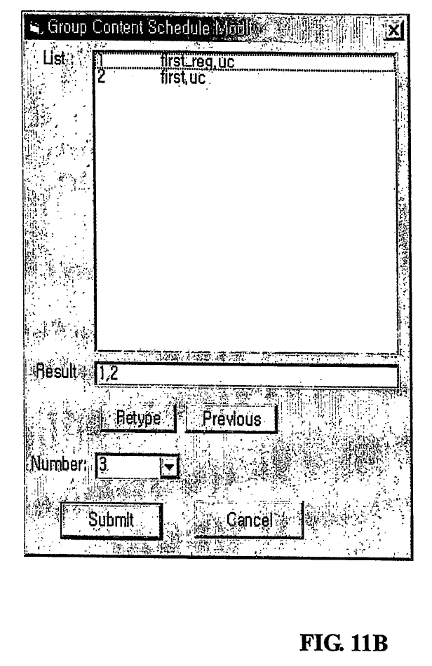

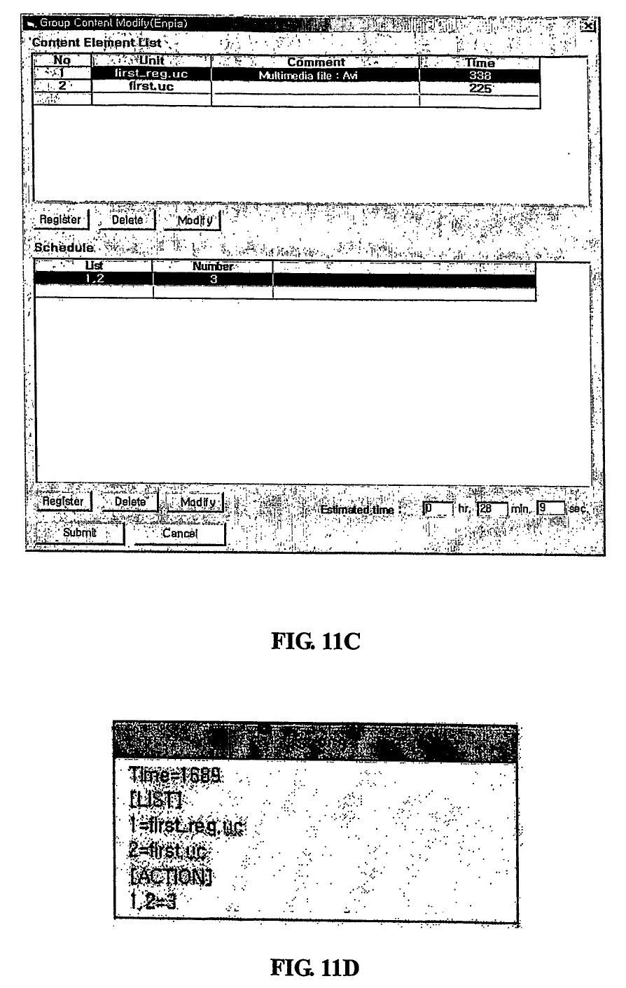

FIG. 11 illustrates an example of management of group content. Group content (20) is an assembly of unit contents (10) and organized through the combination of various unit contents (10). And it is possible to set up the number of display times for each of unit contents (10).

FIG. 11a illustrates a screen for registration of a GCS file for organization of a GCS. After setting up paths about UC (10) files, contents can be managed efficiently by recording detailed information about UC (10).

Figure lib illustrates a screen for management of a GCS schedule. Running order and times of each of UC (10) files organizing GCS (20) are set up.

GCS (20) organization shown in FIG. 11c organized through processes of FIGS. 11a and 11b shows performing first-reg.uc and first.uc file sequentially three times. Organization of GCS (20) contents files of FIG. 11d is based on said input head of FIG. 11c.

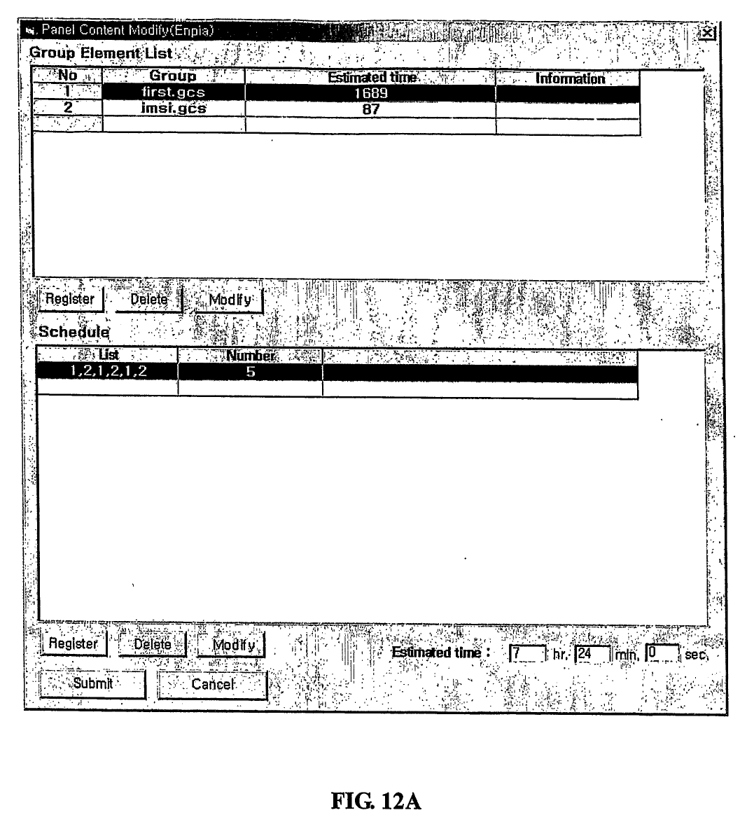

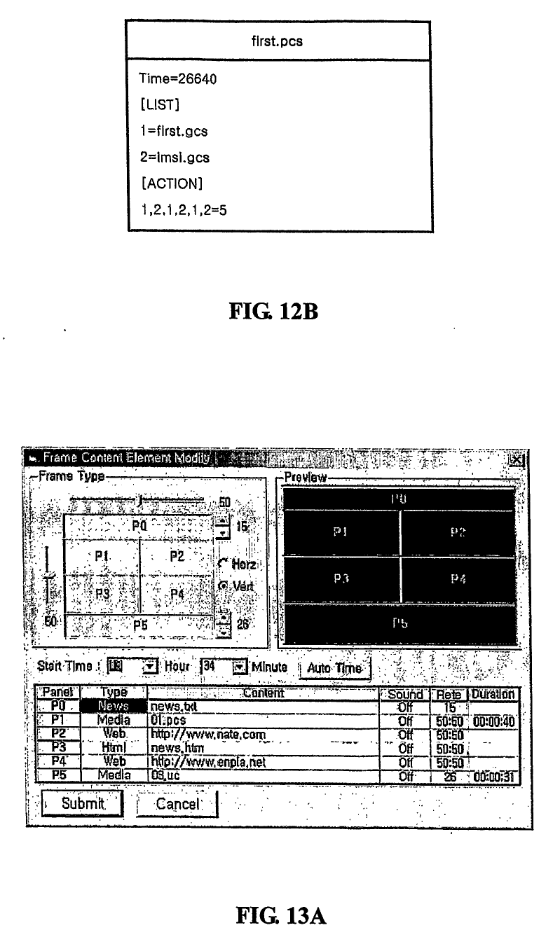

FIG. 12a illustrates an example of PCS management structure. PCS (30) is assembly of the GCS (20) and UC (10). An example of PCS (30) structure of FIG. 12a consists of FIRST.GCS (1) and IMSI.GCS (2) and both GCS sequences are repeated five times, that is, schedules 1, 2, 1, 2, 1, 2 are performed five times sequentially. FIG. 12b shows a file structure of panel content based on the input item of FIG. 12a.

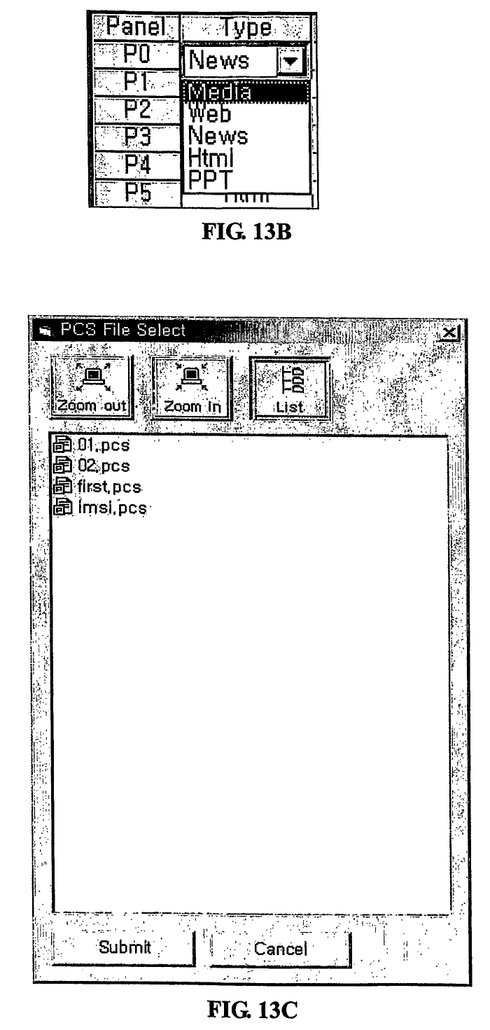

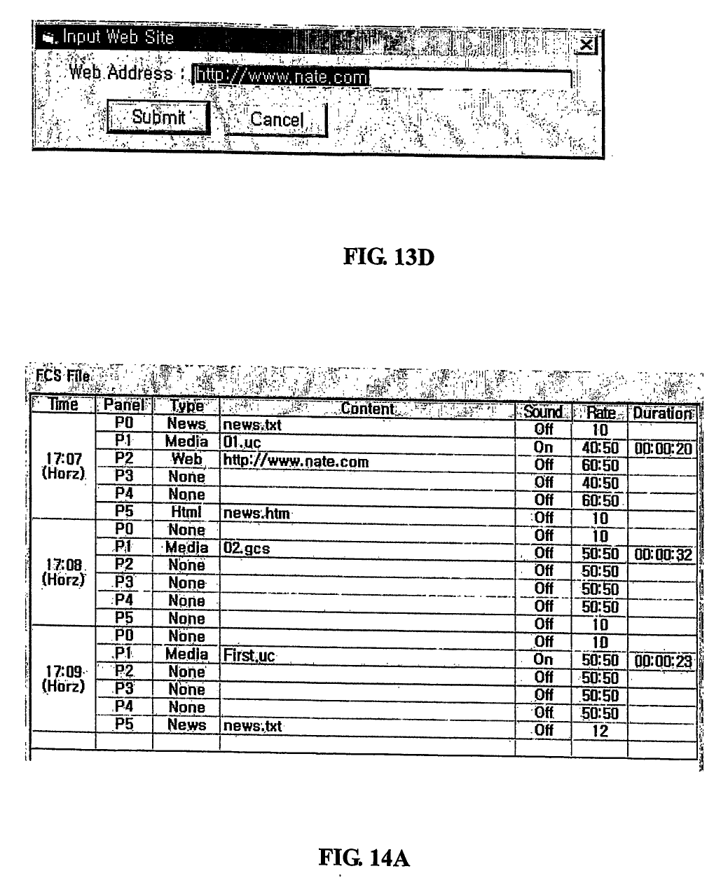

FIG. 13 illustrates an example of Frame Appointment for an FCS (40) setting that is the kernel of organization of IBS schedules. There are bars capable of regulating panel's width and height rates at left side of FIG. 13a. It is possible to preview the arrangement of the frame regulated at the right preview screen by regulating these bars with a mouse. And below of FIG. 13a, contents types, real names of contents files or URL designation, ON/OFF of volume, rate and duration of multimedia files of every panel are designated.

FIG. 13b illustrates an example of appointment of contents type of the panel and the panel type consists of News, Web, URL, Media, Html, PPT, TV, and real-time Streaming server connection largely and can add further registration later.

FIG. 13c illustrates an example of selection of a PCS screen. In selecting media type contents, this invention embodies that it can select and register PCS files registered previously. Contents items such as Zoom in, Zoom out, List view etc are provided variously.

FIG. 13d illustrates an example of a screen selecting corresponding URL in case contents type is designated to Web.

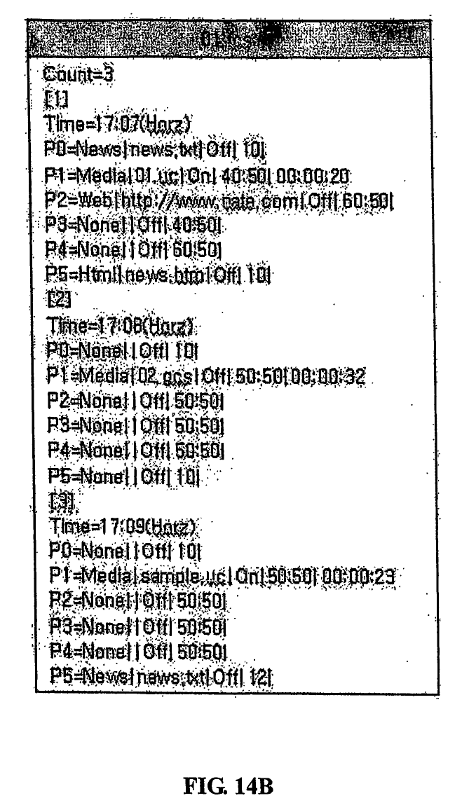

FIG. 14a illustrates an example of broadcasting schedule organization. By setting up broadcasting time, broadcasting panel, broadcasting media type, kind of contents, ON/OFF of volume, screen rate and duration, broadcasting schedules can be organized respectively. Frame size can be set up freely and broadcasting media type supports various types like News, Web, URL, Media, Html, PPT, TV, and real-time streaming server connection etc. Contents can be constructed of UC, GCS, PCS, FCS and URL etc. In case contents consist of multi-screens, a manager can regulate volume of a broadcasting screen according to his own will and duration of multimedia files can be guessed too.

In the broadcasting schedule organization, a UC being a basic element of broadcasting contents is registered (s520), and then GCS or PCS is registered for grouping of registered UC files (s540). And panel playing contents, screen rate and other environments of each frame are registered (s560). IBS Terminal Server runs broadcasting according to registered schedules (s580). In order to register a broadcasting schedule, broadcasting organization table as shown in FIG. 14b must be made. An embodiment of frame content schedule shown in FIG. 14b is based on an input item shown in FIG. 14a.

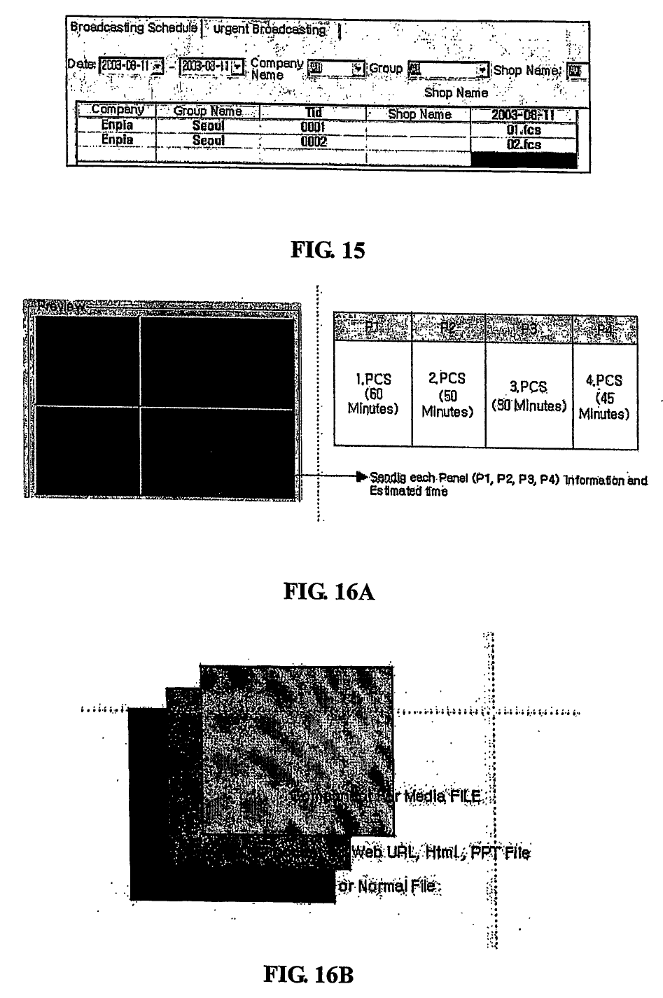

FIG. 15 illustrates an embodiment of a management list of broadcasting schedules. That is, a management list of broadcasting scheduled is divided into general broadcasting schedule item and urgent broadcasting item largely. Contents of broadcasting schedules of the organized UC, GCS, PCS, FCS are designated by company names, group names, TID being id of a terminal, shop names and date. And if it becomes the broadcasting time, broadcasting runs at a corresponding terminal according to FCS of designated schedule. A broadcasting schedule of desired time can be organized through the processes of terminal registration, contents registration, broadcasting registration shown in FIG. 8a FIG. 14b.

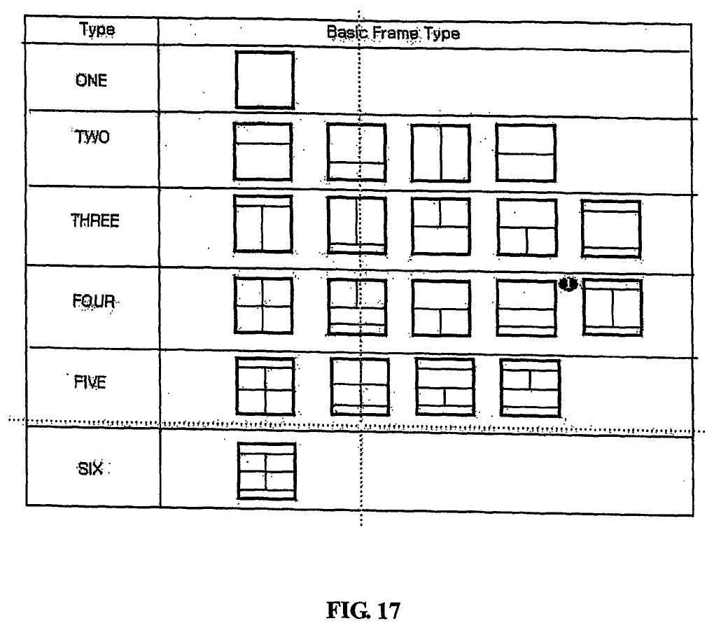

FIG. 16a illustrates an example of structure and control about parted screens according to the present invention. FIG. 16a shows that four screens among the six parted screens shown in FIG. 13a are organized and each panel P1˜P4 plays the schedules 1.pcs˜4.pcs respectively. Here duration of each panel can be set up differently each other. In this embodiment, each of 1.PCS, 2.PCS, 3.PCS and 4.PCS is played for 60, 50, 30 and 45 minutes respectively.

Each panel has panel information about whether there is Next Play to play next time and whether it is END of a schedule and time information of broadcasting being played now. This is basic information for process of urgent messages that may be occurred during broadcasting and it is possible to continuously replay the currently interrupted broadcasting by using this information. In addition if broadcasting of a certain panel finishes early compared to others, broadcasting according to default schedules organized previously or continuous broadcasting of existing broadcasting is provided selectively.

FIG. 16b illustrates an example of structure of OCX (OLE Control Extensions) needed for Screen Frame and control according to the present invention. If broadcasting schedules are received, broadcasting schedule lists are added to OCX for driving Media Player, OCX for driving Web Browser and other OCX in order to control broadcasting and these added schedules perform PLAY, STOP and PAUSE commands. Window events are not embodied according to a certain fixed order but processed whenever process of generated events is demanded. FIG. 16b shows an OCX component for screen control of media moving image files, an OCX component for screen control of Web URL, HTML and PPT files and an OCX component for screen control of *.TXT common files and a proper screen component is controlled according to corresponding panel contents by broadcasting schedules. Moreover OCX components can be utilized variously according to the kind of contents needed to control.

FIG. 17 illustrates an example of basic types about a Screen Frame, which can be expressed through various media at an IBS terminal. IBS screens consist of six panels basically and frame arrangement and broadcasting contents are organized by considering advertisement's efficiency and hardware specification of an IBS Terminal Server (600). The effects of advertisement and broadcasting can be increased because there is no discontinuous playing of broadcasting on a screen or system delay by embodiment of proper media driving and real time broadcasting.

The Screen Frame of an IBS Terminal Server (600) can be implemented by setting up the rate of width and height of basic 6 panels freely as shown in FIG. 17. The arrangement of four parted screens among parted screens shown in FIG. 17 arranges IXT or Web Text at the top area of the screen and arranges multimedia advertisement broadcasting at two panels located at the middle area of it and arranges real time news at the bottom panel area of it and hereby optimal advertisement effects can be expected.

The present invention may be modified and embodied in various forms, and it has been described and illustrated herein with reference to a specific embodiment thereof. However, it should be understood that this invention is not limited to the particular form as described above, and that this invention includes all modifications, equivalents and substitutes within the spirits and scope of this invention as defined in the “Claims” attached hereto.

### THE EXPECTED EFFECTS OF THE PRESENT INVENTION

First, as described above this invention can select a plurality of broadcasting terminals through a centrally controlled method about shop management, general/urgent broadcasting schedule management and contents synchronization and it can broadcast optimal advertisement at a desired time in a selected terminal.

Second, a whole broadcasting management system using centrally controlled method according to the present invention can manage broadcasting optimally by using various screen partition and grouping concept.

Third, in case advertisement contents are mass multimedia data, this invention appoints an optimal path of data transmission between all contents servers so that a system for an original contents server synchronizing the mass multimedia data and a plurality of contents servers receiving the contents does not bear a heavy load and an effect preventing delay of data transmission and bottleneck phenomena of networks previously is expected.

Fourth, it monitors hardware or software defects so that both of the contents servers having defects and transmission paths of data are not appointed and hereby advertisement/broadcasting terminals receive multimedia data smoothly.

Fifth, a security solution server prevents illegal leakage that may occur during multimedia data transmission from an advertisement contents server to an advertisement-broadcasting terminal by using an encryption/compression method of multimedia data.

Sixth, this invention can be utilized in educational systems and other application fields variously as well as in advertisement and broadcasting fields.

Seventh, this invention operates a system by using a centrally controlled method and can transmit moving images in real time and can check remotely whether contents are normal or not and can organize advertisements by date/time/area and hereby target marketing for clients and regions is possible. What is Claimed is:

1. In an Integrated Broadcasting System (IBS) trainsmitting moving images according to real-time/reserved schedules to output terminals of all areas or advertisement points by using a centrally controlled method based on networks including LAN, WAN and Internet and controlling schedules of advertisement/broadcasting, said system controlling and managing advertisement/broadcasting centrally based on networks and comprising:
an IBS Control Server (IBSCS) performing a main role of IBS and a control function about general advertisement and broadcasting schedules, a control function about urgent broadcasting, a management function about customer/terminal information and a control function about contents monitoring and contents transmitting and receiving;
a Security Server (SC) providing a function of encryption and compression of important contents when each broadcasting content is uploaded or downloaded between severs or areas and using a protection technique of transmission path tunneling that cuts off outer illegal usage of contents in transmission processes for security, wherein said protection technique of transmission path tunneling is based on general network techniques embodying data encapsulation in data transmission between OSI 7 Layers;
an IBS Administrator Interface (IBSAI) used as a management tool of GUI environment and providing a function of every environmental setup for driving said IBS and appointment of broadcasting schedules, a management function of broadcasting points, a function of contents grouping, a graphic management function for centrally controlling contents management, schedule management, point management, admin management including manager registration and manager privilege selection and having no restriction of OS platforms in installation and operation of said IBS owing to the development in JAVA environment;
an IBS Terminal Server (IBSTS) being driven at each broadcasting terminal of said IBS and downloading broadcasting time and contents that would play at the broadcasting time and playing broadcasting through various output mediums including displaying devices using various types of monitors comprising a CRT, a PDP, an LCD and a projector being a projecting device, wherein all playing environments about screen structure, the number of times of broadcasting play, screen partition and broadcasting time are downloaded from said IBSCS;
a plurality of IBS Media Servers (IBSMS) organized by server clustering comprising a Content Sender/Receiver Control Unit for in real time transmitting created, modified and deleted contents from Said IBSCS and a Content Database for receiving and storing original advertisement contents, said IBSMS transmitting synchronized contents to Said IBSTS;
a Traffic Management Server (TMS) making broadcasting contents be downloaded from an IBSMS with the best efficiency by using information of network distance between said IBSTS and said IBSMS and system resources of said IBSMS and modulating load distribution and thereby providing a path through which advertisement contents and broadcasting schedules can be downloaded optimally and providing a load balancing function between said IBSMS having the same functions by using server information including CPU, memory and server information of session, an Intelligent Global Load Balancing (GLB) function and a Server Load Balancing (SLB) function and managing transmission traffic of contents and, wherein said GLB distributes PING, HOP between each of said IBS Media Servers and POP and load between POPs distributed locally according to a policy defined by a manager, and said SLB distributes server load between said IBS Media Servers having the same contents by using CPU, memory and session; and
a Content Distribution Server (CDS) monitoring contents change of said IBSMS automatically and distributing changed contents to pre-designated servers in real time and synchronizing contents of said pre-designated servers and making said IBSMS always keep the same contents,
wherein said IBSCS, SS, IBSAI, IBSTS, IBSMS, TMS and CDS operate organically one another and performs organization and management of broadcasting schedules, urgent broadcasting processes and screen partition processes and transmit moving images to every region or output medium of advertisement points by using a centrally controlled method on networks in real time or according to reserved schedules

2. A system controlling and managing advertisement/broadcasting centrally based on networks as set forth in claim 1, wherein it is characterized in that said IBSCS comprises a Broadcasting Schedule Control Unit, a Content Monitoring Control Unit, a Content Sender/Receiver Control Unit, a Shop Management Database Control Unit, a General Broadcasting Schedule Database, an Urgent Broadcasting Schedule Database, a Content Database and a Shop Management Database, and
said Broadcasting Schedule Control Unit stores general broadcasting schedules and urgent broadcasting schedules set up at said IBSAI in a General Broadcasting Schedule Database and an Urgent Broadcasting Schedule Database respectively and takes charge of every control related to schedule transmission when said IBS Terminal Server demands broadcasting schedules, and
said Content Monitoring Control Unit performs monitoring about contents stored in said IBS Control Server in real time and if contents of specifically monitored directories stored in said IBS Control Server are modified, created and deleted, then said Content Monitoring Control Unit can monitor said modified, created and deleted contents at Kernel Level in real time and transmit commands for contents synchronization to said Content Sender/Receiver Control Unit, and
said Content Sender/Receiver Control Unit transmits said modified, deleted and created contents to a plurality of said IBS Media Servers and distribution of said contents in real time by said Content Monitoring Control Unit and said Content Sender/Receiver Control Unit, and
said Shop Management Database Control Unit has function of login authentication of said IBS Terminal Server, function of registration, modification and deletion of said IBS Terminal Server (terminal) and function of IP address confirmation for checking the existence of said IBS Terminal Server in various network environments including ADSL and leased lines, and
said General Broadcasting Schedule Database stores information of broadcasting terminals, broadcasting time and broadcasting schedules, and
said Urgent Broadcasting Schedule Database is a space which stores information of urgent broadcasting and has the same structure with said General Broadcasting Schedule Database, and
said Content Database is a space storing contents of advertisements or broadcasting and stores directory and file structure using file system of said IBS Control Server, and said Shop Management Database stores shop information about said IBS Terminal Server and information about Identification and password.

3. A system controlling and managing advertisement/broadcasting centrally based on networks as set forth in claim 1, wherein it is characterized in that said IBSAI comprises:
a general broadcasting schedule registration unit providing function of controlling set-up, modification and deletion of general broadcasting schedules organized by date and by terminal;
an urgent broadcasting schedule registration unit providing function of controlling set-up, modification and deletion of urgent broadcasting schedules organized by date and by terminal, wherein the urgent broadcasting is distinguished from the general broadcasting;
a contents synchronization unit providing function of uploading and downloading contents from and to said remote IBS Control Server and deleting contents of servers; and
a terminal registration unit providing function for registering Identification, password and server environments of said IBS Terminal Server for transmission of broadcasting.

4. A system controlling and managing advertisement/broadcasting centrally based on networks as set forth in claim 1, wherein it is characterized in that said IBSTSI comprises:
a broadcasting screen control unit controlling how to arrange several panels in one frame;
a login control unit controlling authentication of IP address, other information of connection environment set-up, Identification and password of said IBS Control Server connecting for login authentication of said IBS Terminal Server;
a Content Sender/Receiver Control Unit transmitting and receiving contents from the optimal server among said plurality of IBS Media Servers, wherein said transmitted and received contents correspond to modified, deleted and created contents and said Content Sender/Receiver Control Unit distributes said contents in real time; and a Content Database being a physical hard disk storing contents received from said Content Sender/Receiver Control Unit.

5. A system controlling and managing advertisement/broadcasting centrally based on networks as set forth in claim 1, wherein it is characterized in that said TMS comprises:
a GLB Master to select the optimal POP in case networks are distributed to organize several POPs;
an SLB master to embody server load balancing between IBS Media servers;
a communication module for data transmission;
a control unit controlling each communication module; and
a database for storing GLB information and SLB information.

6. A system controlling and managing advertisement/broadcasting centrally based on networks as set forth in claim 1, wherein it is characterized in that said TMS comprises:
a plurality of listen sockets always maintaining wait status in order to check whether data for decryption is generated or not;
an SSL decryption performing decryption; and
a plurality of connection communication modules connected to said security client, and said security client loaded in said IBSTS comprises:
a plurality of listen sockets always maintaining wait status in order to check whether data for encryption is generated or not;
an SSL encryption performing encryption; and
a plurality of connection communication modules for transmitting said encrypted data to said Security Server.

7. A system controlling and managing advertisement/broadcasting centrally based on networks as set forth in claim 1, wherein it is characterized in that said IBSCS, SS, IBSAI, IBSTS, IBSMS, TMS and CDS are server modules embodied in software form and can be organized in each hardware separately and said CDS, TMS, SS and IIBSCS can be installed in a hardware at the same time.

8. A system controlling and managing advertisement/broadcasting centrally based on networks as set forth in claim 1, wherein it is characterized in that a schedule database for general broadcasting or urgent broadcasting of said IBSCS stores information of company name, group name, TID that is terminal ID inputted when a terminal is registered, shop name, date and FCS as file form.

9. A system controlling and managing advertisement/broadcasting centrally based on networks as set forth in claim 1, wherein it is characterized in that said IBSTS is a PC or a server installed each broadcasting terminal.

10. A system controlling and managing advertisement/broadcasting centrally based on networks as set forth in claim 1, wherein it is characterized in that a frame denotes a whole screen and a panel denotes each separated screen and said IBS embodies basic scheduling by combining basic elements of:
a unit content (UC) denoting each multimedia file;
a group content server (GCS) denoting an assembly of said UC files;
a panel content service (PCS) denoting an assembly of said GCSes; and
an FCS (frame content schedule) denoting an assembly of said PCS, GCS and UC, said FCS being a schedule unit for a day or a certain period.

11. A system controlling and managing advertisement/broadcasting centrally based on networks as set forth in claim 10, wherein it is characterized in that in organizing frames and broadcasting contents with said basic scheduling elements although the names of companies name are identical basically, said frames and broadcasting contents are organized differently each other pursuant to broadcasting terminals, and each panel in a frame is a space capable of playing advertisement and broadcasting by using UC, GCS, PCS and FCS that are single contents scheduled previously.

12. A system controlling and managing advertisement/broadcasting centrally based on networks as set forth in claim 1, wherein it is characterized in that a user gets authentication of an open key through a plurality of authentication methods including Identification, password and finger print and connects with a server program of said IBS and an authenticated user can use a server application and said user can protect contents and important data by using a method for encryption or compression according to each step during data transmission on Internet section.

13. A system controlling and managing advertisement/broadcasting centrally based on networks as set forth in claim 1, wherein it is characterized in that said IBS terminals are registered and managed through said IBSTS and in registration of terminals, terminal Identification and password are inputted and terminals are registered and detail information about hardware of the terminals' computers is recorded and the inputted Information comprises CPU of PC, memory capacity, disk capacity, information about whether ADSL is used or not, operator's name, operator's telephone number, operator's mobile phone number and basic frame size.

14. A system controlling and managing advertisement/broadcasting centrally based on networks as set forth in claim 10, wherein it is characterized in that in designating a frame for organization of said FCS, a panel's width and height rate, a contents type in a panel, appointment of real contents files or URL, ON/OFF of volume, duration time of multimedia files are designated and said contents type in a panel is selected among News, Web, URL, Media, Html, PPT, TV, and real time streaming server connection and further registration is possible later and in case of selecting media type contents, it is possible to register PCS files registered previously and corresponding PCS selection lists provide function of icon view and list view among folder view options of a Window searcher.

15. A system controlling and managing advertisement/broadcasting centrally based on networks as set forth in claim 14, wherein it is characterized in that in case organizing broadcasting schedules, Information about broadcasting media type, kind of contents, ON/OFF of volume, screen rate and broadcasting duration time can be organized respectively and Frame size can be set up freely and broadcasting media type supports various types including News, Web, URL, Media, Html, PPT, TV, and real-time streaming server connection and contents are organized as one among UC, GCS, PCS, FCS and URL and in case contents consist of multi-screens, a manager can select and change a specific panel to turn on sound effect of broadcasting among a plurality of panels according to his own will and it is possible to turn on volume of a panel in order to increase broadcasting effect and grasp the duration time of multimedia files in order to forecast scheduling of contents to be being played at present or to be played in future.

16. A system controlling and managing advertisement/broadcasting centrally based on networks as set forth in claim 15, wherein it is characterized in that in controlling broadcasting screen, it is possible to divide a screen into a plurality of screens and each panel has panel information about NextPlay denoting a schedule to be played next time, information about END of a schedule and information about time to be being played at present and said information becomes basic information for process of urgent messages and it is possible to replay continuously the current interrupted broadcasting by using said information and if there is a panel whose broadcasting is over earlier than other panels, then broadcasting screens according to default schedules organized previously or continuous replaying of existing broadcasting are provided selectively.

17. A system controlling and managing advertisement/broadcasting centrally based on networks as set forth in claim 16, wherein it is characterized in that IBS screens consists of six panels basically and frame arrangement and broadcasting contents are organized based on advertisement efficiency and hardware specification of said IBS Terminal Server and media running and real time broadcasting are performed by consideration of hardware specification of said IBSTS and thus the phenomenon that screen becomes discontinuous or system speed slows is prevented and it is possible to set up the width and height rate of said six basic panels freely in said screen organization and one among text, PPT, web text of html type, multimedia advertisement broadcasting at any place of a plurality of parted screens is arranged.

18. In an Integrated Broadcasting System (IBS) transmitting moving images according to real-time/reserved schedules to output terminals of all areas or advertisement points by using a centrally controlled method based on networks including LAN, WAN and Internet, said IBS having a Content Distribution Server (CDS), a Traffic Management Server (TMS), a Security Server (SS), an IBS Control Server (IBSCS), an IBS Administrator Interface (IBSAI), an IBS Terminal Server (IBSTS) and a plurality of IBS Media Servers (IBSMS), a method for controlling and managing advertisement/broadcasting centrally based on networks by using said system, said method comprising:
if information of broadcasting schedules, contents and clients are registered through said IBS Administrator Interface, a step for transmitting said information to said IBS Control Server and storing said information in a database;
a step for monitoring by said IBSCS whether contents are changed or not based on said transmitted information and transmitting information related to said changed contents to each IBS Media Server and storing said transmitted information in a database of said IBS Media Server;
a step for getting authentication of an IBS terminal through login to said IBS Terminal Server and connecting to said IBS Control Server and downloading corresponding contents through the optimal IBS Media Server and storing said contents in a database of said IBS Terminal Server; and
a step for controlling broadcasting screen of said IBS Terminal Server and broadcasting corresponding broadcasting contents when it becomes broadcasting time.

19. A method for controlling and managing advertisement/broadcasting centrally based on networks as set forth in claim 18, wherein it is characterized in that a transmitting process of general/urgent broadcasting schedules between said IBS Control Server and said IBS Terminal Server comprises:
a step for inputting Identification and password set up when initial registration is made at an IBS terminal and demanding authentication about a demand signal of authentication, a company name and TID (terminal ID);
if said authentication is successful, a step for asking of said IBS Terminal Server to said IBSCS every period whether there are broadcasting schedules in the IBS terminal to reduce server load and increase server efficiency, wherein said period can be set up freely by a manager;
a step for searching of said IBSCS a General Broadcasting Schedule Database and an Urgent Broadcasting Schedule Database in said IBSCS and checking whether there are schedules according to said ask;
if there is urgent broadcasting as a result of said checking, a step for demanding of said IBS terminal detailed schedules about said urgent broadcasting schedules according to the present time;
a step for downloading of said IBS terminal said demanded detailed schedules; and
if there is general broadcasting that is already being played at present as a result of said checking, a step for interrupting of said IBS terminal said general broadcasting and controlling and broadcasting new urgent broadcasting.

20. A method for controlling and managing advertisement/broadcasting centrally based on networks as set forth in claim 19, wherein it is characterized in that an IBS terminal has panel information of each divided frame and information of broadcasting lapse time and thus said IBS terminal can provide continuity of previous broadcasting after ending of urgent broadcasting and it is possible to grasp the current broadcasting status by transmitting the status information of whether the broadcasting to be being played at present is urgent broadcasting or general broadcasting to said IBS Control Server.

21. A method for controlling and managing advertisement/broadcasting centrally based on networks as set forth in claim 18, wherein it is characterized in that the operation flow of said IBS Terminal Server installed at each broadcasting terminal comprises:
a step for getting authentication of said IBS Terminal Server for login;
a step for checking whether there are urgent broadcasting schedules through said IBS Control Server;
if there are urgent broadcasting schedules as a result of said check, a step for downloading urgent schedules produced by an urgent broadcasting scheduler and broadcasting contents;
a step for checking of said IBS Control Server whether there is advertisement running at present in said IBS Terminal Server;
if there is broadcasting running at present, a step for interrupting running of current screen by said IBSCS;
a step for running urgent broadcasting;
if there is no advertisement running at present, a step for by said IBS Terminal Server running urgent broadcasting without delay;
a step for checking by said IBSTS whether there is organization of default pages produced previously;
if there is organization, a step for running default pages;
if there is no organization, a step for checking by said IBSTS whether it is interrupted advertisement broadcasting or not;
if it is interrupted broadcasting, a step for requesting by said IBSTS to run previously interrupted advertisement broadcasting;
a step for running IBS terminal broadcasting screen according to said request;
if there is no urgent broadcasting schedules or if default pages are broadcasted or if there is no interrupted broadcasting or if said IBS Terminal Server runs advertisement broadcasting, a step for checking by said IBS Control Server whether there are general broadcasting schedules;
if there are general broadcasting schedules, a step for downloading by said IBSCS general broadcasting schedules produced by a general broadcasting scheduler and broadcasting contents;
if there is no general broadcasting schedules or if general broadcasting schedules and broadcasting contents are downloaded, a step for checking whether there are registered broadcasting schedules;
if there are registered broadcasting schedules, a step for running general advertisement broadcasting and terminating; and
if there are no registered broadcasting schedules, a step for terminating at once.

22. A method for controlling and managing advertisement/broadcasting centrally based on networks as set forth in claim 18, wherein it is characterized in that IBS security solution that is contents encryption process comprises:
a step for demanding authentication of open-key through one among various authentication means including Identification, password and fingerprint; and
a step for by said authenticated user connecting to a server program and using various server applications and using encryption or compressing method according to step for safe data transmission between a TCP/IP layer and application at Internet section and protecting contents and important data.

23. A method for controlling and managing advertisement/broadcasting centrally based on networks as set forth in claim 18, wherein it is characterized in that a central management method of contents through said IBS Administrator Interface comprises:
a step for providing function of contents management, media management, Unit Content Management, group content management, Panel Content Management, Frame Content Management by said IBS Administrator Interface;
a step for classifying said contents into general text format files including general PPT, TXT, HTML and multimedia files including MPEG, AVI and MP3 and managing said contents;
a step for showing contents list through a contents management item and providing function of file information and file review;
a step for showing Tree Structure about contents and providing information whether corresponding files are normal or not and preview function in selecting each content at Tree Structure;
a step for providing information about whether corresponding media files are normal or not, whether there are corresponding files at local, whether there are corresponding files at a server and providing version information, file information, file preview function and selecting contents and previewing said selected contents through said file preview function after downloading servers' contents files to local PCs; and
in selecting each contents at said Tree Structure, a step for providing information about version, preview, whether corresponding files are normal or not, whether corresponding files are at local or not, whether corresponding files are at servers, whether basic files are normal or not, and making it possible to check whether uploaded or downloaded files operate normally, whether contents files are damaged and performing uploading or downloading again for abnormal files.

24. A method for controlling and managing advertisement/broadcasting centrally based on networks as set forth in claim 18, wherein it is characterized in that a management method of unit content that is minimal unit of IBS contents comprises:
a step for storing information about names of companies performing contents registration, media file names, explanation about files, display time of files, panel size of width×height, clients' company names, contents types; and
a step for registering contents at media item in registering unit contents and inputting values of other items including display time and original panel size of corresponding media files automatically.

25. A method for controlling and managing advertisement/broadcasting centrally based on networks as set forth in claim 24, wherein it is characterized in that a frame designation method for FCS set-up in designation of IBS schedules comprises:
a step for setting a selected panel's width and height rate, contents types in panels, real names of contents files or URL, ON/OFF of volume and duration time of multimedia files;
a step for letting contents types of said panels consisting of News, Web, URL, Media, Html, PPT, TV, and real time streaming server connection be registered further later and registering PCS files registered previously in selecting media type contents;
a step for providing function of icon view and list view among folder view options of a Window searcher; and
a step for selecting a corresponding URL through designating a contents type to Web.

26. A method for controlling and managing advertisement/broadcasting centrally based on networks as set forth in claim 18, wherein it is characterized in that in organization of broadcasting schedules, information about broadcasting time, broadcasting panel, broadcasting media type, kind of contents, ON/OFF of volume, screen rate and duration time are organized and frame size can be organized freely and broadcasting media type supports various types including News, Web, URL, Media, Html and PPT and contents are organized with UC, GCS, PCS, FCS and URL and contents can be organized into multi screens and in this case a manager can regulate volume of broadcasting screen according to his will and duration time of multimedia files can be expected.

27. A method for controlling and managing advertisement/broadcasting centrally based on networks as set forth in claim 26, wherein it is characterized in that an organizing process of said broadcasting schedules comprises:
a step for registering UC being a basic element of broadcasting contents;
a step for registering GCS or PCS for grouping of UC files;
a step for registering panel playing contents, screen rate and other environments for each frame; and
a step for playing at a specific IBS Terminal Server according to said registered schedules,
wherein a predetermined broadcasting organization table must be made in order to register a broadcasting schedule

28. A method for controlling and managing advertisement/broadcasting centrally based on networks as set forth in claim 27, wherein it is characterized in that in order to manage broadcasting schedules, the contents of UC, GCS, PCS and FCS consisting of lists for managing predetermined broadcasting schedules are designated by the contents of company names, group names, terminals, TID being ID of a terminal for distinction and date and if corresponding broadcasting schedules are designated, then broadcasting is played at each corresponding terminal by FCS that is a designated schedule and a broadcasting schedule at a desired time through terminal registration, contents registration, broadcasting schedule registration is organized.

29. A method for controlling and managing advertisement/broadcasting centrally based on networks as set forth in claim 18, wherein it is characterized in that in control process of a broadcasting screen, a broadcasting screen is organized with a plurality of screens and a PCS schedule corresponding to each panel is played and each panel has information about whether there is Next Play to be played next time, whether it is END of a schedule and time information of broadcasting being played and said information becomes basic information for processing urgent messages capable of being generated during broadcasting and continuous broadcasting of the present interrupted broadcasting is played again by using said information and if there is a panel whose broadcasting is over earlier than other panels and then broadcasting screen according to a default schedule organized previously or existing broadcasting is provided continuously and selectively.

30. A method for controlling and managing advertisement/broadcasting centrally based on networks as set forth in claim 29, wherein it is characterized in that basic OCX (OLE Control Extensions) for screen playing control comprises:
a step for adding broadcasting schedule list to OCX for driving a Media Player, OCX for driving Web Browser and other OCX for controlling broadcasting if broadcasting schedule is received;
a step for performing of said added schedule PLAY, STOP and PAUSE commands by using outer interface;
a step for processing event process whenever said event process generating Window events is demanded; and
a step for controlling a appropriate screen component according to the kinds of contents of a corresponding panel among OCX component for screen controlling of Media moving image files being applicable diversely according to the contents to be controlled, OCX component for screen controlling of Web URL, Html and PPT files and OCX component for screen control of general *.TXT files by broadcasting schedules.

31. A method for controlling and managing advertisement/broadcasting centrally based on networks as set forth in claim 18, wherein it is characterized in that IBS screens provides six parted panels basically to construct a frame that can be expressed through various media at an IBS terminal and frame arrangement and broadcasting contents are organized by considering advertisement's efficiency and hardware specification of said IBS Terminal Server and the effects of advertisement and broadcasting increase without discontinuous playing of broadcasting on a screen or slowing system by embodiment of proper media driving and real time broadcasting and the screen of said IBS Terminal Server can be organized by setting up the rate of width and height of basic six panels freely and TXT or web document is arranged at the top area of basic six parted screens and multimedia advertisement broadcasting is arranged at two panels located at the middle area of the basic six parted screens and real time news is arranged at the bottom panel area of the basic six parted screens and a screen is parted and contents are organized to get the optimal advertisement effects but every panel supports every type of broadcasting media including type, TEXT, MEDIA, Web URL, HTML, PPT and real-time news.
